(19) United States
(12) Patent Application Publication
(10) Pub. No.: US 2015/0107690 A1
(43) Pub. Date: Apr. 23, 2015

(54) TEXTURED CLOSURE SURFACE FOR FUEL VAPOR VALVE

(71) Applicant: Eaton Corporation, Cleveland, OH (US)

(72) Inventor: Paul D. Walkowski, Ann Arbor, MI (US)

(21) Appl. No.: 14/580,396

(22) Filed: Dec. 23, 2014

Related U.S. Application Data
(63) Continuation of application No. PCT/US2013/031479, filed on Mar. 14, 2013.
(60) Provisional application No. 61/670,788, filed on Jul. 12, 2012.

(51) Int. Cl. B60K 15/035; F16K 24/04; F16K 1/36; F16K 29/00

(52) U.S. Cl. CPC B60K 15/03519; F16K 29/00; F16K 24/044; F16K 1/36; B60K 2015/03289
USPC 137/202

(57) ABSTRACT

A valve assembly is provided for venting pressure in a fuel tank. The valve assembly includes a float member that is movable between a first position and a second position. A flexible seal is supported on the float member. The valve assembly also includes a valve port that may define an orifice and a closure surface surrounding the orifice. The closure surface may include textured features that are configured to engage a surface of the seal when the float member is in the second position.

### CROSS-REFERENCE TO RELATED APPLICATIONS

This application is a continuation of and claims the benefit of PCT Application No. PCT/US2013/031479, filed on Mar. 14, 2013, which claims the benefit of U.S. Provisional Application Ser. No. 61/670,788, filed Jul. 12, 2012, the disclosure of which is incorporated herein by reference in its entirety.

### TECHNICAL FIELD

The present teachings relate to valve seals, and more particularly to a closure surface for a fuel vapor valve.

### BACKGROUND

Fuel vapor valves of the float-operated type operate by closing a vent port in a fuel tank when the fuel level in the tank reaches a set or predetermined level. These valves may include a relatively thin elastomeric seal that can engage a closure surface of the vent port to close the valve. The valve port may have a relatively large circumference to provide the desired vapor flow at low vapor pressures. As a result, a relatively low closing force can be used to seal the elastomeric seal against the closure surface. When the fuel level in the tank drops below the predetermined level, the valve is configured to reopen and release fuel vapor through the valve port.

However, the quality of the seal may also be affected if the elastomeric seal sticks to the closure surface before the seal squarely orients itself relative to the closure surface. Further, increased vapor pressure in the fuel tank along with the relatively large circumference of the valve port can cause the elastomeric seal to remain engaged against the closure surface, thereby preventing the valve from opening. In other words, the valve sticks and remains closed in situations where it is desired for the valve to be open.

Thus, it is desirable to provide a closure surface for a valve port to allow a elastomeric seal to slide into place during engagement and seal squarely against the closure surface. It is also desirable to provide a closure surface that traps liquid for lubrication of the elastomeric seal but does not provide a leak path. It is also desirable to provide a closure surface that allows the elastomeric seal to reopen with a low peel-away force.

### SUMMARY

A valve assembly is provided for venting pressure in a fuel tank. The valve assembly includes a float member that is movable between a first position and a second position. A flexible seal is supported on the float member. The valve assembly also includes a valve port that defines an orifice and a closure surface surrounding the orifice. The closure surface includes textured features that are configured to engage a surface of the seal when the float member is in the second position.

Various aspects of the present teachings will become apparent to those skilled in the art from the following detailed description of the embodiments, when read in light of the accompanying drawings.

### BRIEF DESCRIPTION OF THE DRAWINGS

Embodiments of the invention will now be described, by way of example, with reference to the accompanying drawings, wherein:

FIG. 1 is a representative diagram of a sealing interface for a valve according to an aspect of the present teachings, the valve being illustrated in an open position;

FIG. 2 is a representative diagram of the sealing interface of FIG. 1, where the valve is in a closed position;

FIG. 3 is a perspective view of an embodiment of a textured closure surface at the sealing interface of FIGS. 1 and 2;

FIG. 4 is a representative diagram of the textured closure surface according to an aspect of the present teachings;

FIG. 5 is a cross-sectional view of a valve port having a textured closure surface with an annular ring around an orifice according to another aspect of the present teachings; and

FIG. 6 is a perspective view of the valve port and textured closure surface generally illustrated in FIG. 5.

### DETAILED DESCRIPTION

Reference will now be made in detail with respect to embodiments of the present teachings, examples of which are described herein and illustrated in the accompanying drawings. While concepts will be described in conjunction with embodiments, it will be understood that the invention is not intended to limit the specific disclosures associated with the embodiments. On the contrary, the invention is intended to cover alternatives, modifications and equivalents, which may be included within the spirit and scope of the invention as defined by the appended claims.

Valves, such as inline check valves or other valves, may include an elastomeric seal that selectively engages with a valve closure surface to open and close the valve. To ensure low leakage, the seal should close and remain closed with the application of a very low closure force, for example and without limitation, on the order of 5 to 10 grams of force.

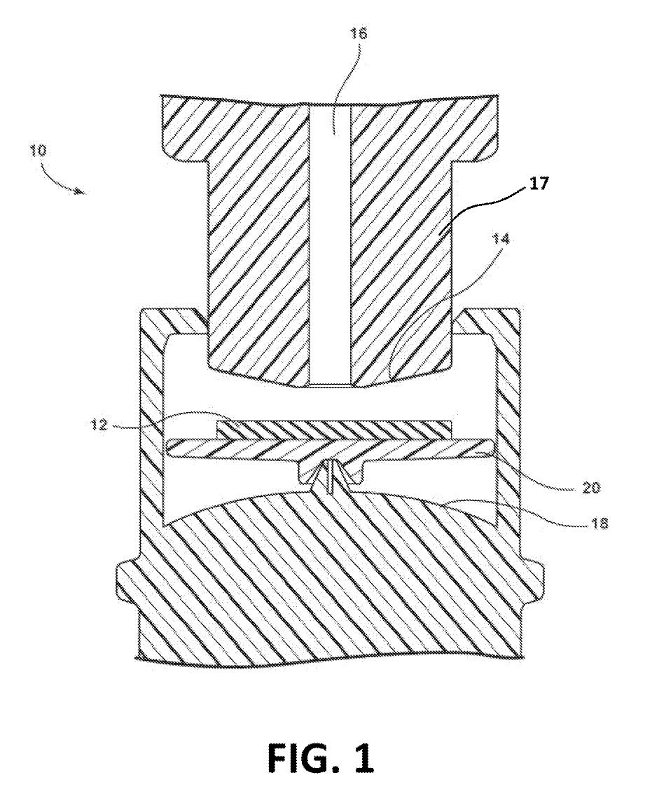

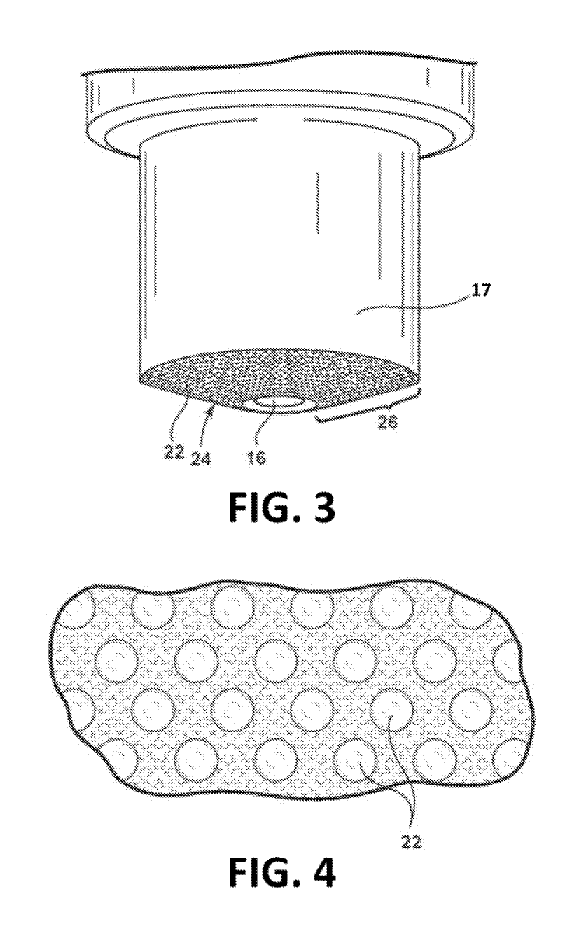

FIGS. 1 through 3 are representative diagrams of an embodiment of a valve assembly having a sealing interface 10 according to an aspect of the teachings. The sealing interface 10 includes a seal 12, such as an elastomeric seal, that engages with a closure surface 14 surrounding an orifice 16 of a valve port 17. The seal 12 may be disposed on top of a float 18 in a float valve, such as a grade vent valve, fuel limit vent valve, or other fuel tank valve. The orifice 16 can be coaxially aligned with the float 18. In an aspect of the teachings, the float 18 moves upward when the fuel level in the fuel tank rises and moves downward when the fuel level in the fuel tank drops. When the float 18 rises to a selected level, the seal 12 engages the closure surface 14 to close the orifice 16 and shut the valve port 17. A spring or spring mechanism may provide an additional upward force to the float 18 when the valve is in an upright state.

In one aspect of the teachings, the seal 12 can be disposed on top of a flapper 20. In embodiments, the flapper 20 may be coupled to the float 18 such that the flapper 20 may position itself for a secure connection between the seal 12 and the closure surface 14. The example illustrated in the figures shows a gimbaled connection between the flapper 20 and the float 18; however, other forms of connection can be used without departing from the scope of the teachings.

To improve the sealing properties of the interface 10, the closure surface 14 may include a plurality of features 22 that create a texture on the closure surface 14. The features 22 can be designed to allow the seal 12 to slide into place and seal squarely against the closure surface 14. In an embodiment, the features 22 may be smooth, microstructured raised features and/or pits arranged in a pattern , which may be a regular pattern. The features 22 may be formed as a microscopic surface texture on the closure surface 14. FIG. 4 generally illustrates a possible pattern for the features 22. However, for embodiments, the specific pattern may not matter as long as it is a regular (i.e., not random) pattern. For example and without limitation, features 22 may be a regular pattern of dimples, such as those observed on a golf ball. Other features may include ridges, V-shaped grooves, pores, or other shapes designed to trap liquid, decrease friction, and enhance lubrication on the closure surface 14 while preventing leakage when the valve is closed, even when the seal 12 and closure surface 14 engage at random orientations. Possible methods of engineering the features 22, for example, are described in U.S. Published Application 2001/0089604 and U.S. Published Application 2010/00319183, U.S. Published Application 2011/0226724, and U.S. Published Application 2011/031176.

When the seal 12 contacts the closure surface 14, the features 22 can trap liquid to lubricate the interface 10 while also blocking a leak path, thereby creating a low- or no-leak interface 10. The features 22 may also allow the seal 12 and the closure surface 14 to close securely at any random orientation while still allowing the seal 12 to peel away from the closure surface 14 with relatively low force. More particularly, the features 22 may allow excess fluid, which can cause the seal 12 to stick, to drain away from the interface 10.

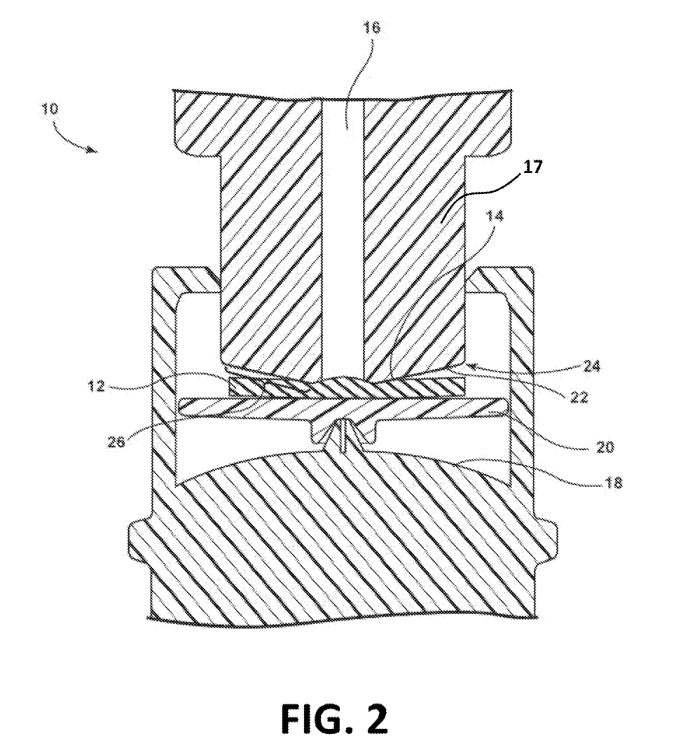

To further improve sealing, the closure surface 14 may include a tip 24 that is slightly tapered or conical and has a smooth radius that blends toward the orifice 16, such as generally illustrated in the figures. When the seal 12 contacts the tip 24, particularly at a transition 26 from the conical portion to the radius, the seal 12 may deform slightly against the tip 24, such as generally shown in FIG. 2, effectively increasing the sealing contact area, until a static force balance is achieved. In other words, the seal 12 may stretch slightly as it deforms against the tip 24, thereby wrapping slightly around a portion of tip 24 and improving sealing contact with the closure surface 14.

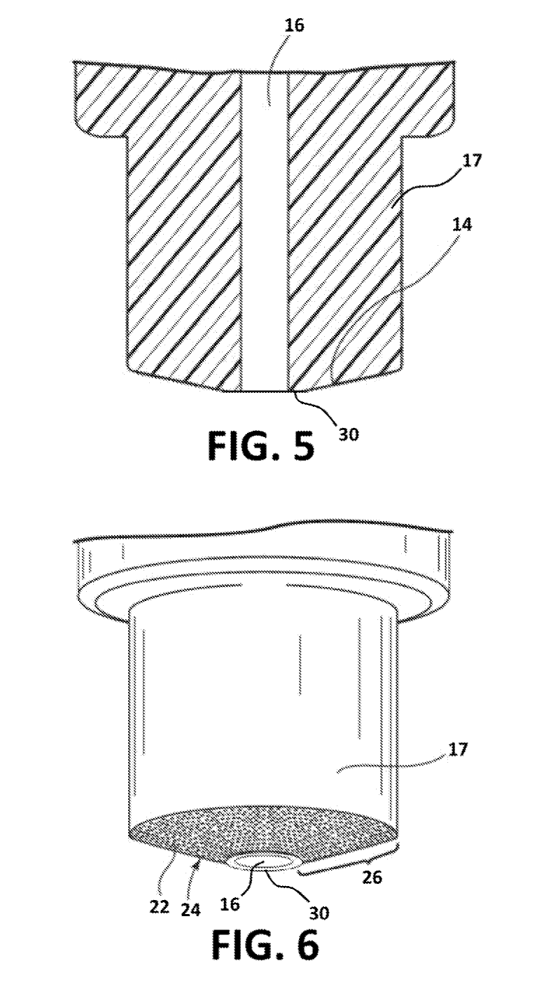

In another aspect of the present teachings, for example as generally illustrated in FIGS. 5 and 6, the closure surface 14 may include an annular ring portion 30 that extends around an open end of the orifice 16. As shown, the annular ring 30 can be surrounded by textured features 22. The annular ring 30 may have a substantially flat surface with a mirror finish or any other generally smooth finish. The annular ring 30 may have any suitable diameter or width to achieve desired functionality. For example, without limitation, the annular ring 30 may define a 1 millimeter wide flat surface.

It will be appreciated that the above teachings are merely exemplary in nature and is not intended to limit the present teachings, their application or uses. While specific examples have been described in the specification and illustrated in the drawings, it will be understood by those of ordinary skill in the art that various changes may be made and equivalents may be substituted for elements thereof without departing from the scope of the present teachings as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A valve assembly for venting pressure in a fuel tank, the valve assembly comprising:
a float member movable between a first position and a second position;
a flexible seal supported on the float member; and
a valve port that defines an orifice and a closure surface surrounding the orifice, wherein the closure surface includes textured features that are configured to engage a surface of the seal when the float member is in the second position.

2. The valve assembly of claim 1, wherein the textured features are microscopic raised structures that extend from the closure surface.

3. The valve assembly of claim 2, wherein the microscopic raised structures are generally smooth.

4. The valve assembly of claim 1, wherein the textured features are arranged in a regular pattern.

5. The valve assembly of claim 1, wherein the closure surface defines a conical tip of the valve port.

6. The valve assembly of claim 5, wherein the seal is deformed by the conical tip of the valve port when the seal is engaged with the closure surface.

7. The valve assembly of claim 5, wherein the seal wraps around a portion of the conical tip of the valve port when the seal is engaged with the closure surface.

8. The valve assembly of claim 1, wherein the closure surface includes an annular ring portion that extends around an open end of the orifice.

9. The valve assembly of claim 8, wherein the annular ring portion defines a generally flat surface that is surround by the textured features.

10. The valve assembly of claim 9, wherein the generally flat surface of the annular ring portion has a mirror finish.

11. A valve assembly for venting pressure in a fuel tank, the valve assembly comprising:
a float member movably supported within a housing between a first position and a second position;
a flexible seal movably supported on the float member; and
a valve port defining an orifice that is coaxially aligned with the float member, the valve port having a closure surface that surrounds an open end of the orifice and includes textured features that are configured to engage a surface of the seal when the float member is in the second position.

12. The valve assembly of claim 11, wherein the textured features are microscopic raised structures that extend from the closure surface.

13. The valve assembly of claim 12, wherein the microscopic raised structures are generally smooth.

14. The valve assembly of claim 11, wherein the textured features are arranged in a regular pattern.

15. The valve assembly of claim 11, wherein the closure surface defines a conical tip of the valve port.

16. The valve assembly of claim 15, wherein the seal is deformed by the conical tip of the valve port when the seal is engaged with the closure surface.

17. The valve assembly of claim 15, wherein the seal wraps around a portion of the conical tip of the valve port when the seal is engaged with the closure surface.

18. The valve assembly of claim 11, wherein the closure surface includes an annular ring portion that extends around the open end of the orifice.

19. The valve assembly of claim 18, wherein the annular ring portion defines a generally flat surface that is surround by the textured features.

20. The valve assembly of claim 19, wherein the generally flat surface of the annular ring portion has a mirror finish.
